(19) United States
(12) Patent Application Publication
(10) Pub. No.: US 2008/0176616 A1
(43) Pub. Date: Jul. 24, 2008

(54) Numerical Target Card Game

(76) Inventor: Steven Kenneth Wright, Menifee, CA (US)

Correspondence Address: SoCAL IP LAW GROUP LLP, 310 N. WESTLAKE BLVD. STE 120, WESTLAKE VILLAGE, CA, 91362, US

(21) Appl. No.: 12/057,288

(22) Filed: Mar. 27, 2008

Related U.S. Application Data
(63) Continuation of application No. 11/131,016, filed on May 17, 2005, now abandoned.

(51) Int. Cl. A63F 13/00; A63F 1/00

(52) U.S. Cl. 463/12; 273/292

(57) ABSTRACT

There is disclosed a method of playing a card game between a player/dealer, which may be a computing device, and one or more players. Each of the one or more players may place a wager. A hand of two cards may be dealt to each of the one or more players and the player dealer. The cards may be dealt from one or more decks of cards, each deck including four Aces having a value of one or eleven, four each of cards having values of two through nine, and sixteen cards having a value of ten. The dealt hands may be evaluated adding the values of the two cards comprising each hand. A hand consisting of an Ace and one of at least some of the sixteen cards having a value of ten receives an additional value of 0.5, whereby the total hand value is 21.5.

### RELATED APPLICATION INFORMATION

This patent is a continuation of Ser. No. 11/131,016, filed May 17, 2005, entitled “Texas 21.5 Blackjack Card Game”.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This invention is in the general field of casino gaming and, more particularly, is a variation of the game of commonly known as blackjack. Furthermore, this invention relates to a card game such as would be played at a casino and to a table, special deck of cards, player positions and wager card and bet placement areas.

2. Description of the Related Art

Blackjack is a game played at a semicircular table with seven player stations equally spaced on the table's top near an arcuate edge thereof. There is an imprint of a circle at each player station. A player places cheques or chips representative of a wager within the circle. A player/dealer is positioned near a straight edge of the table. The player/dealer faces the player. Blackjack is played with one or more standard decks of cards. An ace dealt to a player has a point value of either “1” or “11” at the election of the player; a face card (jack, queen or king) has a point value of “10” and each of the remaining cards (“2” through “10”) have a point value equal to what is alternatively referred to as a “pip” value or a number value of the card. Point values of cards held by the player are added together to obtain a player total point value. A player/dealer total point value is obtained in a similar manner.

After the bets are placed within the imprinted circle, the cards are shuffled and the player and the player/dealer are each dealt a hand comprised of two cards. The cards of the player's hand are dealt face-up. A first card of the player/dealer's hand is dealt face-down. A second one of the player/dealer's hand is dealt face-up.

Whenever the player/dealer face-up card is either an ace or has a point value of “10”, the player/dealer ascertains the point value of the face-down card without revealing it to the player unless the player/dealer total point value is “21”. When the two cards of the player/dealer hand cause the player/dealer total point value to be “21”, the player/dealer is said to have blackjack whereupon the player/dealer turns the face-down card face up. Similarly, when the two cards of the player hand causes the player total point value to be “21”, the player is said to have blackjack.

When the player/dealer has blackjack, the player/dealer wins the wager with two exceptions. A first exception occurs when the player/dealer's face up card is an ace and the player posts cheques or chips representative of what is known as an insurance bet which is typically equal to one half of the wager. When the player/dealer does not have blackjack, the player loses the insurance bet. When the player/dealer has blackjack, the cheques or chips representative of the wager and the insurance bet are returned to the player.

The second exception occurs when the player has blackjack whereupon the cheques or chips representative of the wager are returned to the player. The second exception is an example of when the player hand and the player/dealer hand have the same total point value and is referred to as a push.

When the player has blackjack and the player/dealer does not, the player wins the wager. When neither the player/dealer nor the player has a blackjack, the player has four options.

A first option is to have the player hand augmented by an additional card (referred to as a “hit”). The player may have successive hits until the player total point value exceeds “21”. When the total point value of a hand exceeds “21” it is said to bust. The player loses the wager when the player hand busts. Therefore, busting is a sudden, catastrophic termination of play for the player.

A second option is not to have the player hand augmented by the additional card (referred to as a “stand”). The player may stand at any time that the player hand has not busted.

A third option, referred to as doubling down, permits the player to double the wager and receive one additional card.

A fourth option is available when the player hand is comprised of two cards that are a pair, such as a pair of queens, for example. The player may split the pair into first and second player hands. An additional card is dealt to the first player hand and to the second player hand, each of which are played as described hereinbefore.

The decision to hit or stand is made with an objective of causing the player total point value to be closer to “21” than the player/dealer total point value without busting. It should be understood that central factors in making the decision are the player/dealer's face-up card and the player total point value.

After the player stands, the player/dealer's face-down card is turned face-up, whereby both cards of the player/dealer hand are faced-up. When the player/dealer total point value is less than “17”, then the player/dealer must hit until the player/dealer total point value is at least “17”. When a hit causes the player/dealer hand to bust and the player hand has not busted, the player wins the wager.

It should be understood that when an exemplary hand includes an ace and a six, for example, it is referred to as a soft “17” because the ace causes the exemplary hand to have alternative point values of “7” and “17”. Usually, the player/dealer hand cannot be hit when it is the soft “17”, although some casinos have must hit “soft” rules.

When neither the player hand nor the player/dealer hand busts and the player/dealer total point value exceeds the player total point value, the player/dealer wins and vice versa. When there is a push, there is no winner; the cheques or chips representative of the wager are returned to the player.

A desirable aspect of blackjack is its simplicity. However, is blackjack can be made more interesting by providing play that requires an inclusion of bonus cards in the decks of cards and by providing play instead of the bust when the player point value exceeds “21”. The inclusion of the bonus cards and providing play when the player point value exceeds “21” need not be a compromise of simplicity.

### SUMMARY OF THE INVENTION

According to the present invention, TEXAS 21.5 BLACKJACK is a game that utilizes a fifty-two card deck with aces through nines (the standard spades, hearts, clubs and diamonds) and 16 bonus cards (four “W's”, four “X's”, four “Y's”, and four “Z's”. The bonus cards are worth 10 unless dealt with an Ace on the initial deal. The bonus card is worth 10.5 points when dealt with an Ace on the initial deal. A player and a player/dealer are each dealt a hand of two cards. One of the player/dealer's cards is dealt face-up; the other is dealt face down. The bonus card and Ace combination is considered a Bonus Blackjack 21.5 and pay one and one half if dealt to a Player or if dealt to the payer/dealer wins all hands unless another player also has a Bonus Blackjack 21.5 in which case, the player and the player/dealer push.

A bonus is a hand that consists of a bonus card and an ace that are initially dealt to a player or player/dealer. The bonus outranks all other hands. A hand has a total point value of “21.5” when it includes the initial combination of a bonus card and an ace. The player may hit, double-down, split a pair or surrender to acquire a final player hand when the player/dealer's face-up card is not a bonus hand. When a player/dealer hand has a total point value that is a soft “17” or less, a player/dealer must take a hit to acquire a final player/dealer hand. When the final player hand and the final player/dealer hand have total point values that are greater than “21.5” A) If the payer's and the payer/dealer's cards match exactly, the hand is a push or tie. Examples of this are: If the player's hand is 9, 8, 6 (23 total) and the player/dealer's hand contains a 9, 8, and 6 or if the player's hand is Bonus Card, 6, 9 and the player/dealer's hand contains a Bonus Card, 6 and 9. When the total point values are each greater than “21.5”, with the dealer point value being closer to “21.5” than the player point value, the player loses.

### DESCRIPTION OF THE DRAWINGS

These advantages may be more clearly understood from the following detailed description and by reference to the drawings in which:

FIG. 1 is perspective view of a typical poker table, showing the general position of the player/dealer station and a first design of eight player's stations.

FIG. 2 is a top view of the table, showing the general position of the player/dealer station and a second design of the eight player stations.

FIG. 3 is representation of the modified card deck used in conjunction with the present invention game, showing an ace card, a bonus card, and with a nine card and a two card representing the range between the nine and two card yielding 32 numbered cards.

FIG. 4 is a flow chart of the preferred method of play.

### DETAILED DESCRIPTION

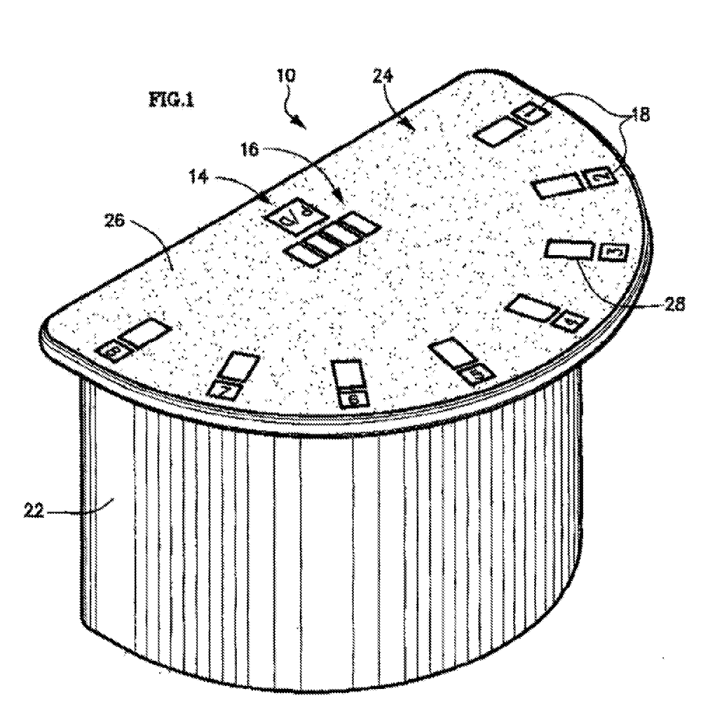

FIG. 1 shows a perspective view of the eight hand table to be used for the card game with a playing surface. Nothing particular about the design of the table is important to the present invention as long as it serves to provide access to a typical card game with individual stations. The table generally designated 10 can be very similar to or may be a conventional poker table as used in gaming casinos. The table 10 is generally elliptical or “D” shaped with a vertical support 22 may be one piece as shown or a veneer wrapped around legs (not shown). In addition a foot rail (not shown) may be attached to the support 22 for the feet of the players.

The top of the table 24 is fitted with a playing surface or “felt” 26 which is usually a green felt pad with various indicia printed thereon for various player positions or player stations designated 18. The player stations 18 have a rectangle shaped card placement area 28.

The table 10 is also equipped with a player/dealers area 14 that is positioned in the back of the table and facing the player stations 18. The player/dealer area 14 has a four card receiving area 16 used for placement of the players/dealers cards.

The particular table 10 illustrated in the drawings is designed to allow eight players represented by the numbers “1” to “8” therein to play there around. Thus, on the felt 26 there are illustrated eight player stations designated 18. As represented in FIG. 1, the eight player stations are designed in a “Las Vegas” style. The player/dealer can be referred as the house/banker in the “Las Vegas” style.

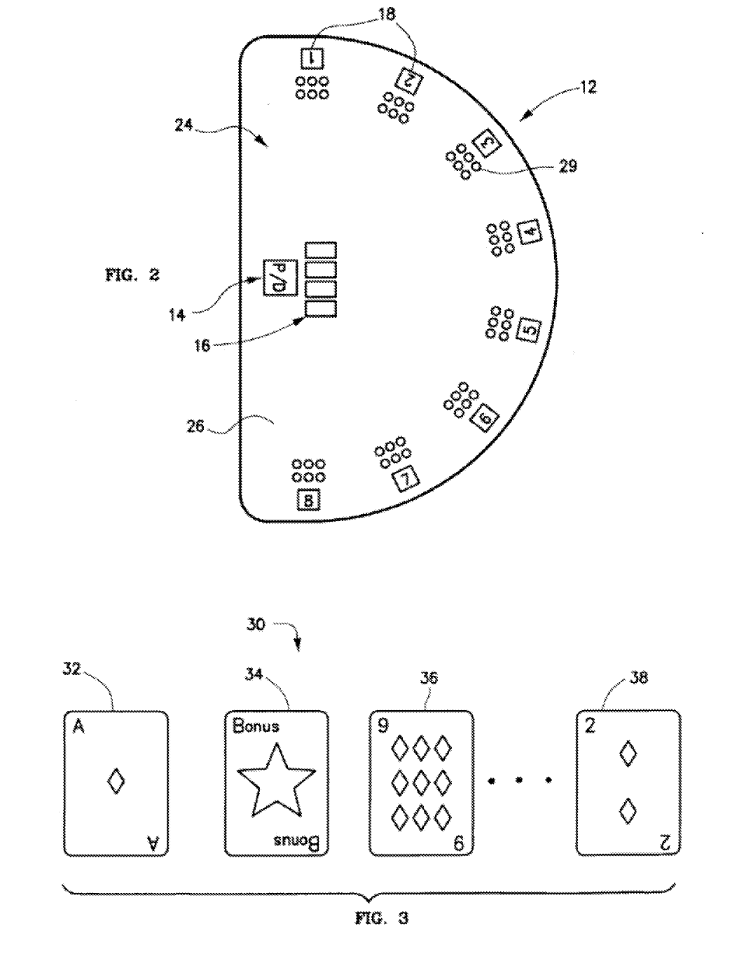

FIG. 2 shows a top view of the table 12 and the general position of the player/dealer station 14 and a second design of the eight player stations 20. The table 12 is also equipped with a player/dealers area 14 that is positioned in the back of the table and facing the player stations 20. The player/dealer area 14 has a four card receiving area 16 used for placement of the players/dealers cards. The particular table 20 illustrated in the drawings is designed to allow eight players represented by the numbers “1” to “8” therein to play there around. Thus, on the felt 26 there are illustrated eight player stations designated 18. The player stations 18 have a six circle betting area 29. As represented in this FIG. 2, the eight player stations are designed in a “California” style.

Object of the Game

The object of Texas 21.5 Blackjack is for the players and the Player/Dealer to add the numerical value of their cards and:

Achieve the best possible point total of 21.5 by getting a “Bonus” card and an Ace on the initial two cards dealt. This hand pays 3 to 2.

Get as close to 21.5 as possible, without going over.

Draw additional cards if needed.

Value of the Cards

TEXAS 21.5 BLACKJACK is a game use a fifty-two card deck with aces through nines (the standard spades, hearts, clubs, and diamonds) and 16 bonus cards (four “W” bonus cards, four “X” bonus cards, four “Y” bonus cards, and four “Z” bonus cards). The games can be played with a minimum of one (1) and a maximum of eight (8) decks.

A “BONUS” card 34 and an Ace 32, on the initial deal, is the best possible hand. It is known as a Texas 21.5 Blackjack and pays 3 to 2.

One “BONUS” card 34 dealt with any other card is worth 10 and is added to the other card(s) point total.

An Ace 34 has a value of either 1 or 11.

All cards from two 36 to nine 38 equal their face value.

“BONUS” cards 34 have a value of 10 unless dealt with an ace 32 on the initial deal.

Ranking Chart
CARD VALUE

| BONUS* | 10 or 10.5 when initially dealt w/an ace |
|---|---|
| Ace | 1 or 11 |
| Two | 2 |
| Three | 3 |
| Four | 4 |
| Five | 5 |
| Six | 6 |
| Seven | 7 |
| Eight | 8 |
| Nine | 9 |

*Bonus card is worth 10, except when dealt with an Ace on the first two cards of the initial deal, whereupon, it will be worth 10.5 and the hand a Texas 21.5 Blackjack when the player/dealer has a Texas 21.5 blackjack, there will be no draw and all hands will be compared to the player/dealer final total.

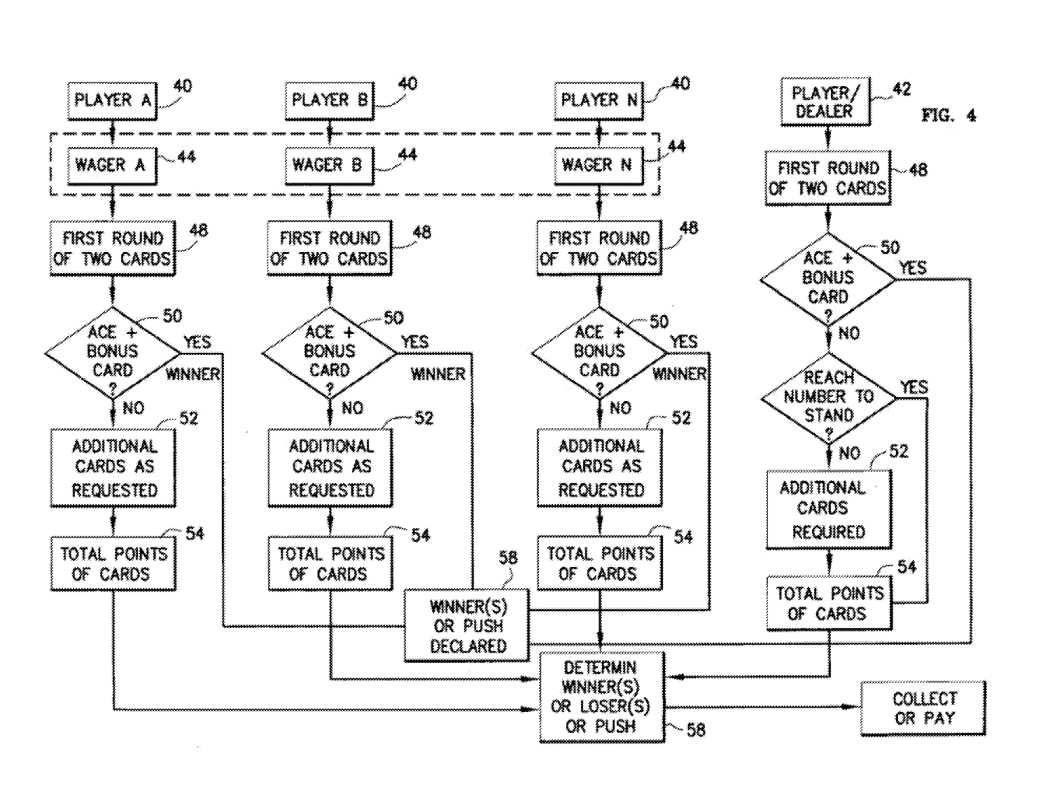

Now referring to FIG. 4, the flow chart of the preferred method of play is describe in more detail below.

Round of Play

1. Texas 21.5 Blackjack is played on a raised gaming table 10,12. The table seats eight players 40 who face the player/dealer 42 in a 180-degree seating arrangement. The tables 10 are the standard blackjack tables commonly used in the casino industry. The casino player/dealer 42 stands opposite the players 40, and in the center of the table. The casino player/dealer's chip tray is set in front of the player/dealer. The play starts from the right of the player/dealer 42 and proceeds in a clockwise fashion.

2. The game uses use a 52-card deck with aces through nines (the standard spades, hearts, clubs, and diamonds) and 16 bonus cards (four “W” bonus cards, four “X” bonus cards, four “Y” bonus cards, and four “Z” bonus cards). The game is played with a minimum of a single deck, totaling fifty two cards and to a maximum of eight decks totaling four hundred twenty four (424) cards.

3. All tables 10, 12 will have some type of signage where the name of the game is displayed, along with the minimum and maximum wager allowed the collection fee for the players and Player/Dealer will also be displayed. A maximum of three collection rates is allowed in compliance with the California Penal Code.

4. A standard round of play begins when a Player/Dealer 42 is designated. The Player/Dealer 42 will place an amount of money (casino chips) in a betting circle in front of their seat. That money will be used to pay the winners and will set the amount that he/she can collect for the losers. The casino will place a button in front of the Player/Dealer 42, which designates that they are taking the “bank position and further designate whether it is the first or second turn for the Player/Dealer 42 in the banking position. The Player/Dealer 42 will place the collection fee in front of his/her betting circle.

5. Players 40 at a table then place their wager 44 in designated betting circles. The players 40 may place a wager 44 at his/her seat along with other unoccupied betting circles. Each player must pay the posted collection for the wager they placed in any betting circle where they have money or “action”.

6. Once the Player/Dealer 42 has posted the amount of money, he/she will wager against the other players 40, and once the players 40 have placed their wagers 44, the casino player/dealer will collect all of the fees. This will always be accomplished before the start of the game in accordance with the California Penal Code. The casino Player/Dealer 42 will take the collection fees and drop them into a locked collection box affixed to the gaming table.

7. After the fees have been collected, the player/dealer 42 will deal the cards to the players 40 and the player/dealer 42. All cards dealt throughout the game are face up, with the exception of the Player/Dealer's second card, which will remain “face down” until all players have acted on their hands. The casino player/dealer 42 is the only person on the table allowed to touch the cards. The players 40 will signal the player/dealer with hand gestures that indicate whether the wish to hit or stand. The hand signals will be consistent with the industry standard signals of a sweeping motion towards a players body, indicating a hit, or a side to side hand motion, indicating the desire to stand. The casino player/dealer deals the first card to the player seated to the left of the designated Player/Dealer, in a clock-wise manner. Each player 40 will be dealt one card face up with the Player/Dealer receiving the last card. The Player/Dealer's cards will be placed in front of the casino player/dealer. (The game can also be played European style, that's were the player/dealer get one card on the initial deal. Each player gets one card on the first round face up, on the second round all the players get their second card except the player/dealer. When all players have finished their hands and have final totals the player/dealer will draw until they have a final total.)

8. The casino player/dealer 42 will deal a second card to the players in the same order noted above 48. The players 40 are given an opportunity, starting with the player seated to the left of the Player/Dealer 42, to be dealt addition cards 52 to make the best possible hand. (Rules and procedures for splitting, doubling down, and surrendering will be outlined later)

9. Players 40 must follow the below listed Charts 1A and 1B in deciding whether to hit of stand on a particular hand.

10. After all players 40 have acted on their hands and indicated to the casino player/dealer 42 that they do not want or cannot receive additional cards, the Player/Dealers 42 down card will be turned up. This down card will determine where the “action button” is placed.

11. The “action button” determines where the action starts and who will be first to be paid for their winning hand or lose their wager. The action button is placed based on the numerical or letter value of the Player/Dealer's down card.

12. The Player/Dealer's hand will then be completed according to the rules listed on Chart 1B. Once the Player/Dealer's hand is completed, the payoff and/or collection of wagers will begin in the seat designated by the action button and continue in a clockwise manner until all wagers have been acted on.

13. In the event that the Player/Dealer 42 does not have enough money on the table to cover all the wagers 44 on the table, there will be no free collection button, refund, or other conciliatory action given to the affected players by the casino or the Player/Dealer 42.

14. The Player/Dealer's cards will always be dealt and placed in front of the casino player/dealer's tray. The placement of the Player/Dealer's cards is standard in all games and is depicted below.

15. After all wagers are settled, the cards are collected and discarded. The bank button is changed from 1st Bank to 2nd Bank and after every two hands, the Player/Dealer position is rotated in a clockwise fashion around the table.

16. The next round of play begins when the casino player/dealer collects all the cards from the table and places them in the discard tray. The casino player/dealer will also change the bank button, and if necessary (if the same person has already held the Player/Dealer position twice) rotate the Player/Dealer position clockwise to the next position on the table. If there is no person that intervenes on the Player/Dealer's position, the game will be “broken” or stopped, as required by the California Penal Code.

CHART 1A
Player Options

| Must Stand on | Must Hit on | Have Option on |
|---|---|---|
| Hard 19 or more (may split | Hard 11 or less | All other counts |
| two Bonus Cards) | | |

CHART 1B
Player/Dealer Options

| Must Stand on | Must Hit on | Have Option on |
|---|---|---|
| Hard 17 or more | Soft 17 or less | None |

Game Rules

1. A Texas 21.5 Blackjack (an Ace and a Bonus card) 50 is the best possible hand. If the player and the Player/Dealer's hand are both Texas 21.5 Blackjack 50 the hand is a push of tie, and no action is taken on the wager.

2. If the Player/Dealer 42 does not have a Texas 21.5 Blackjack 50, the Players 40 will be given the option to draw to improve their hands 52, in accordance with Chart 1A above. The Player/Dealer's down card will be checked for a “Texas 21.5 Blackjack” when the Player/Dealer's first or up card is an Ace 32 or Bonus Card 34.

3. After all Players 40 have been given a chance to act on their hands, the Player/Dealers hand will be completed in accordance with Chart 1B.

4. If a Player's total 54 is less than a “Texas 21.5 Blackjack” and the Player/Dealer's total 54 is more than a “Texas 21.5 Blackjack”, the Player 40 wins 58 the hand.

5. If a Player's total 54 is more than a “Texas 21.5 Blackjack” and the Player/Dealer's total 54 is less than a “Texas 21.5 Blackjack”, the Player loses the hand.

6. If a Player and the Player/Dealer have the same total 54 and it is less than a “Texas 21.5 Blackjack”, the hand is a push or tie. No action is taken on the wager.

7. If a Player's total 54 and the Player/Dealer's total 54 are less than a “Texas 21.5 Blackjack”, the hand closest to a “Texas Blackjack 21.5” will win 58.

8. If a Player's total 54 and the Player/Dealer's total 54 and more than a “Texas 21.5 Blackjack”, the following will apply:

A) If the Player's and the Player/Dealer's cards match exactly, the hand is a push or tie. Examples of this are: If the Player's hand is 9, 8, 6 (23 total) and the Player/Dealer's hand contains a 9, 8, and 6 or if the Player's hand is Bonus Card, 6, 9 and the Player/Dealer's hand contains a Bonus Card, 6 and 9.

B) If the Player's cards and the Player/Dealer's cards do not match exactly, the Player/Dealer wins 58.

9. The game is played on an industry standard Blackjack table where up to eight primary players can be seated.

10. All collection fees will be collected by the casino dealer, prior to the start of play. Collection fees will be determined by the casino and can be up to three separate rates per game.

11. All collection rates and wagering limits will be posted at the table. They will not be based on any percentage.

12. Backline betting is allowed; subject to local ordinance or code.

13. Third Party Providers of Proposition Player Services, as defined in Section 19984 of the California Business and Professions Code, are permitted to play.

Double-Down, Split, and Surrender

1. Players 40 can double-down on their first two cards dealt to them. The player 40 must place a second wager equal to the player's original wager. The player 40 will only receive one additional card, regardless of the total. Doubling down for less is allowed.

2. Players 40 can split any pair or two BONUS cards 34. The player 40 must place a second wager equal to the original wager. The player 40 may draw as many cards as desired per split card. When splitting two Aces 32, the player 40 only receives one additional card per ace. There is no splitting for less.

3. A maximum of three splits is allowed per hand.

4. Players 40 can surrender after their first two cards are dealt to them. If the up card is BONUS CARD OR ACE the casino/dealer will check to see if its blackjack before the draw, if it's a blackjack there will be no draw and all hands will be compared, If there is no blackjack then the player will have the to choose if they wish to surrender, If the player choose to surrender, half of their wager will be forfeited. The player must indicate their desire to surrender before the Player/Dealer's down card is exposed and before the player has acted on their hand. Their play for the hand will then cease.

5. The casino will take no extra collection fee on double downs or splits from the player or Player/Dealer 42.

6. All payoffs are to the extent that the Player/Dealer's money covers the action on the table. A Player/Dealer cannot win or lose more than the entire amount of money placed on the table before the start of the hand.

Options

The following options are available for individual casinos to cater to the needs of their customers:

Over 21.5 Options (when both the Player and Player/Dealers total 54 is more than a Texas 21.5 Blackjack 50).

Over 21.5 Variation #2:

a) Player and Player/Dealer both have the same (over) total—Player/Dealer wins.

b) Player's (over) total is closer to 21.5 than the Player/Dealer's (over) total-Push

c) Player/Dealer's (over) total is closer to 21.5 than the Player's (over) total—Player/Dealer wins.

Over 21.5 Variation #3

a) Player and Player/Dealer both have the same (over) total—Push

b) Player's (over) total is closer to 21.5 than the Player/Dealer's (over) total—Player/Dealer wins

c) Player/Dealer's (over) total is closer to 21.5 than the Player's (over) total—Player/Dealer wins

### Bonus Card Options

10's Version—The four “W” Bonus Cards are removed from the deck and replaced by four 10's. An Ace and a Ten (10) dealt to a Player on the first two cards would be worth 21 not 21.5.

Jacks and 10's Version—The four “W” Bonus Cards and the four “X” Bonus Cards are removed from the deck and replaced by four 10's and four Jacks. Like the 10's Version, an Ace and either a Jack or Ten (10) on the first two cards would be worth 21 not 21.5. A Bonus Card and either a Jack or 10 may be split.

It is anticipated by the Applicant that the Texas 21.5 Blackjack present invention can be played as digital Texas 21.5 Blackjack video type card game played on a video machine, such as a slot machine. It is also anticipated by the Applicant that the Texas 21.5 Blackjack present invention can be played as a video type “live” Texas 21.5 Blackjack card game played over the internet using an appropriate server that allows many players to participate in playing the live Texas 21.5 Blackjack type card game.

Closing Comments

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

It is claimed:

1. A method of playing a card game between a player/dealer, which may be a computing device, and one or more players, comprising:
each of the one or more players placing a wager
dealing a hand of two cards to each of the one or more players and the player dealer, wherein the cards are dealt from one or more decks of cards, each deck including four Aces having a value of one or eleven, four each of cards having values of two through nine, and sixteen cards having a value of ten
evaluating the dealt hands by adding the values of the two cards comprising each hand,
wherein a hand consisting of an Ace and one of at least some of the sixteen cards having a value of ten receives an additional value of 0.5, whereby the total hand value is 21.5.

2. The method of playing a card game of claim 1, wherein
when the player/dealer has a total hand value of 21.5, the player/dealer wins all wagers against players who do not have a total hand value of 21.5
when a player has a total hand value of 21.5, the player wins their wager unless the player/dealer also has a total hand value of 21.5
when both a player and the player/dealer have a total hand value of 21.5, the wager is a draw.

3. The method of playing a card game of claim 2, further comprising, when the player/dealer was not dealt a two-card hand having a value of 21.5, each player who was not dealt a two-card hand having a value of 21.5 electing whether or not to be dealt one or more additional cards.

4. The method of playing a card game of claim 3, wherein each player who was not dealt a two-card hand having a value of 21.5 must receive an additional card if the value of their hand is less than or equal to a first predetermined value, and must not receive an additional card if the value of their hand is equal to or greater than a second predetermined value.

5. The method of playing a card game of claim 4, wherein the first predetermined value is eleven and the second predetermined value is a hard nineteen, wherein a hard nineteen is any combination of cards having a total value of nineteen except combinations including an Ace evaluated as eleven.

6. The method of playing a card game of claim 3 further comprising:
when the player/dealer and at least one player were not dealt a two-card hand having a value of 21.5 and after each player who was not dealt a two-card hand having a value of 21.5 has completed electing whether or not to be dealt additional cards, the player/dealer receiving an additional card if the value of their hand is equal to or less than a third predetermined value.

7. The method of playing a card game of claim 6, wherein the third predetermined value is a soft seventeen, wherein a soft seventeen is any combination of cards including an ace evaluated as one and having a total value of seventeen

8. The method of playing a card game of claim 6, further comprising settling wagers after all cards have been dealt.

9. The method of playing a card game of claim 8, wherein
if the value of the player/dealer's hand and the value of a player's hand are both less than 21.5
the wager is a push if the player/dealer's hand and the player's hand have the same value
the player/dealer wins if the value of the player/dealer's hand is greater than the value of the player's hand
the player wins if the value of the player's hand is greater than the value of the player/dealer's hand
if the value of the player/dealer's hand is less than 21.5 and the value of a player's hand is over 21.5, the player/dealer wins
if the value of the player/dealer's hand is over 21.5 and the value of a player's hand is less than 21.5, the player wins.

10. The method of playing a card game of claim 9, wherein
if the value of the player/dealer's hand and the value of a player's hand are both over 21.5, the player/dealer wins except that the wager is a push when the cards in the player/dealer's hand and the cards in the player's hand match exactly.

11. The method of playing a card game of claim 9, wherein
if the value of the player/dealer's hand and the value of a player's hand are both over 21.5, the player/dealer wins except that the wager is a push when the value of the player/dealer's hand and the value of a player's hand are the same.

12. The method of playing a card game of claim 9, wherein
if the value of the player/dealer's hand and the value of a player's hand are both over 21.5, the player/dealer wins except that the wager is a push when the value of the player's hand is less than the value of the player/dealer's hand.

13. The method of playing a card game of claim 1, wherein
a hand consisting of an Ace and any one of the sixteen cards having a value of ten receives an additional value of 0.5, whereby the total hand value is 21.5.

14. The method of playing a card game of claim 1, wherein
a hand consisting of an Ace and any one of a predetermined twelve of the sixteen cards having a value of ten receives an additional value of 0.5, whereby the total hand value is 21.5.

15. The method of playing a card game of claim 1, wherein
a hand consisting of an Ace and any one of a predetermined eight of the sixteen cards having a value of ten receives an additional value of 0.5, whereby the total hand value is 21.5.

16. A method of playing a card game between a player/dealer, which may be a computing device, and one or more players, comprising:
dealing a hand of two cards to each of the one or more players and the player dealer
evaluating the dealt hands
wherein a best possible hand has a value of 21.5.

17. The method of playing a card game of claim 16, wherein the value of 21.5 is achievable by adding a 0.5 value bonus to the value of hands containing predetermined combinations of cards.

18. The method of playing a card game of claim 17, wherein the value of 21.5 can be achieved only by adding a 0.5 value bonus to the value of a two-card hand consisting of an ace and a card having a normal value of ten.

19. The method of playing a card game of claim 16, wherein the cards are dealt from one or more decks of cards, each deck including four Aces having a value of one or eleven, four each of cards having values of two through nine, and sixteen cards having a normal value of ten.

20. A computing device for playing a game between a player/dealer, which may be the computing device, and one or more players, comprising
a processor
a memory coupled with the processor
a storage medium having instructions stored thereon which when executed cause the computing device to perform actions comprising
each of the one or more players placing a wager
dealing a virtual hand of two cards to each of the one or more players and the player dealer, wherein the cards are dealt from one or more virtual decks of cards, each deck including four Aces having a value of one or eleven, four each of cards having values of two through nine, and sixteen cards having a value of ten
evaluating the dealt hands by adding the values of the two cards comprising each hand,
wherein a hand consisting of an Ace and one of at least some of the sixteen cards having a value of ten receives an additional value of 0.5, whereby the total hand value is 21.5.

21. A computing device for playing a game between a player/dealer, which may be the computing device, and one or more players, comprising
a processor
a memory coupled with the processor
a storage medium having instructions stored thereon which when executed cause the computing device to perform actions comprising
dealing a virtual hand of two cards to each of the one or more players and the player dealer
evaluating the dealt hands
wherein a best possible hand has a value of 21.5.
